(19) United States
(12) Patent Application Publication
(10) Pub. No.: US 2011/0127218 A1
(43) Pub. Date: Jun. 2, 2011

(54) Regenerator Configurations and Methods with Reduced Steam Demand

(75) Inventors: Satish Reddy, Irvine, CA (US); Jeffrey Scherffius, Aliso Viejo, CA (US)

(73) Assignee: FLUOR TECHNOLOGIES CORPORATION, Aliso Viejo, CA (US)

(21) Appl. No.: 12/867,921

(22) PCT Filed: Feb. 18, 2009
(86) PCT No.: PCT/US09/34405

§ 371 Date: Feb. 3, 2011

Related U.S. Application Data
(60) Provisional application No. 61/029,536, filed on Feb. 18, 2008.

(51) Int. Cl. B01D 61/36

(52) U.S. Cl. 210/640; 210/637; 210/180

(57) ABSTRACT

Steam for use as stripping medium in a regenerator is recovered from a portion of the regenerator bottom product using a pervaporation unit. In most preferred aspects, the portion is selected such as to maintain neutral water balance in the stripper for a desired regeneration level.

This application claims priority to our copending U.S. provisional application with the Ser. No. 61/029,536, which was filed Feb. 18, 2008.

### FIELD OF THE INVENTION

The field of the invention is configurations and methods of regeneration of solvents, and particularly steam regeneration of amine-based solvents.

### BACKGROUND OF THE INVENTION

Various configurations and methods are known in the art to remove acid gas from a process gas (e.g., various distillation-, adsorption- and absorption processes), and among those, regenerator-absorber systems are frequently employed as a relatively robust and cost-efficient gas purification system.

In a typical regenerator-absorber system, a process gas is contacted in an absorber in a counter-current fashion and the acid gas (or other undesirable gaseous component) is at least partially absorbed by a lean chemical solvent to produce a rich solvent and a purified process gas. The so formed rich solvent is then heated in a cross heat exchanger and subsequently stripped at relatively low pressure in a regenerator using steam. The so stripped solvent (i.e., lean solvent) is then cooled in the cross heat exchanger to reduce the temperature in the lean solvent before completing the loop back to the absorber. Therefore, regenerator-absorber systems typically allow continuous operation at relatively low cost.

To increase capacity for carbon dioxide removal in such systems, the temperature in the regenerator may be increased. However, increased corrosivity and solvent degradation often limit the degree of optimization for this process. Also, increased operating temperature will often lead to increased operating expenses. Still further, and particularly where relatively large quantities of carbon dioxide are to be removed, substantial quantities of steam are often required in the regenerator to produce a sufficiently lean solvent. However, large quantities of steam are often costly to produce. Worse yet, where external live steam is used, the water balance of the operation is often affected and excess water needs to be removed.

Thus, there is still a need to improve solvent regenerator configurations and methods to reduce energy requirements while maintaining a desirable performance.

### SUMMARY OF THE INVENTION

The present invention is directed to configurations and methods of regeneration of a solvent, and especially to recovery and re-use of steam from an aqueous solvent using one or more pervaporation units. In most typical aspects of the inventive subject matter, the solvent comprises water and at least one organic and/or inorganic agent that is suitable for the capture (adsorption or absorption) and recovery of a desired component. In such cases, at least some of the desired component is released in the regenerator, typically by some combination of energy (such as heat) and/or pressure reduction.

In one particularly preferred aspect of the inventive subject matter, a method of regenerating a (typically amine-based) solvent includes a step of stripping the solvent in a regenerator using steam as a stripping medium to produce a regenerator overhead and a regenerator bottom product. In a further step, at least a portion of the regenerator bottom product is passed through a pervaporation unit to produce a vapor phase that is enriched in steam, and in yet another step, the vapor phase is fed into the regenerator to thereby supply at least part of the stripping medium.

Viewed from a different perspective, a method of providing steam to a steam regenerator is contemplated in which the regenerator is configured to produce a regenerator bottom product from an aqueous solvent. In such methods, a portion of the regenerator bottom product is passed across a pervaporation unit to so form a steam permeate, and the so formed steam permeate is then fed to the steam regenerator.

It is generally preferred that the pressure of the portion of the regenerator bottom product is increased upstream of the pervaporation unit and/or that a vacuum unit is operated downstream of the pervaporation unit to produce a pressure gradient across the pervaporation unit. Where desired, the vapor phase may be compressed prior to feeding of the vapor phase into the regenerator (e.g., using a compressor or ejector). Alternatively, the compressor may also be omitted where the permeate is already at or above regenerator pressure. It is further contemplated that the quantity of regenerator bottom product may vary depending on operation conditions, desired degree of regeneration, however, it is especially preferred that the portion of the regenerator bottom product is selected such that the amount of steam in the vapor phase is equal to the amount of steam required for regeneration of the solvent in the regenerator to a desired degree. In some aspects, the portion of the regenerator bottom product will be between 10 vol % and 40 vol %, more typically between 40 vol % and 70 vol %, and most typically between 70 vol % and 100 vol % of total regenerator bottom product. Therefore, neutral water balance may be maintained for the regenerator. While not limiting to the inventive subject matter, it is generally preferred that another portion of the regenerator bottom product is combined with the retentate from the pervaporation unit to form a combined lean solvent, which is typically fed to an absorber to form a rich solvent that is then recycled back to the regenerator.

Consequently, in a still further aspect of the inventive subject matter, a solvent regeneration system is contemplated that includes a steam regenerator that is configured to allow use of steam as a stripping medium to so produce a regenerator overhead and a regenerator bottom product. A pervaporation unit is then fluidly coupled to the steam regenerator to allow feeding of at least a portion of the regenerator bottom product to the pervaporation unit to so produce a vapor phase that is enriched in steam, wherein the pervaporation unit is further configured to allow feeding of the vapor phase into the regenerator to thereby supply at least part, and preferably all, of the stripping medium.

It is generally preferred that such systems further include a pump that is fluidly and upstream coupled to the pervaporation unit, and a vacuum pump that is fluidly and downstream coupled to the pervaporation unit to generate a pressure gradient across the pervaporation unit. Additionally, or alternatively, a compressor may be fluidly coupled to the pervaporation unit to provide the vapor phase as a compressed stream to the steam regenerator. Alternatively, it may be advantageous to operate the permeate side of the pervaporation system at the regenerator pressure such that a compressor is not required. Most typically, contemplated systems will also include a conduit to combine the retentate from the pervaporation unit with another portion of the regenerator bottom product, which are then fed to an absorber to produce a rich solvent for regeneration in the regenerator.

Various objects, features, aspects and advantages of the present invention will become more apparent from the following detailed description of preferred embodiments of the invention.

### BRIEF DESCRIPTION OF THE DRAWING

FIG. 1 is an exemplary schematic of one contemplated regeneration system.

### DETAILED DESCRIPTION

The inventors have discovered that steam for use as stripping medium in a regenerator for a solvent, and especially an aqueous chemical solvent, can be recovered from a portion of the lean solvent using a pervaporation unit. The so recovered steam is then reintroduced into the regenerator, typically after compression to suitable pressure. Most notably, it should be appreciated that the portion of the lean solvent can be selected such that the regenerator has a neutral water balance for any desired degree of solvent regeneration. Such configurations and methods will advantageously reduce energy costs associated with otherwise required steam production and condensation to control the water balance of the regenerator. Most typically, the solvent is an aqueous solvent comprising water and at least one organic and/or inorganic reagent that is suitable for the capture (adsorption or absorption) and recovery of a desired component (typically an acid gas such as CO2 and/or H2S), and the desired component is at least partially released in the regenerator by some combination of energy (e.g., heat) and/or pressure reduction. As used herein, the term “pervaporation unit” refers to a system in which a liquid feed is fed to a membrane, wherein the membrane is configured to separate a vapor permeate (through the membrane) from a liquid retentate.

In one especially preferred aspect, steam for stripping a solvent in a regenerator is drawn from at least a portion of the regenerated solvent using a separation system that preferentially (i.e., greater 50% selective), and more preferably selectively (i.e., greater 90% selective) separates water from the organic component of a solvent. In especially preferred aspects, the separation system is a pervaporation system in which a membrane provides selective permeability for water, and the solvent is an aqueous solution of an amine. For example, suitable amines include various alkanolamines such as monoethanolamine (MEA), diethanolamine (DEA), methyldiethanolamine MDEA, etc., or other amines such as diisopropylamine (DIPA) or diglycolamine (DGA).

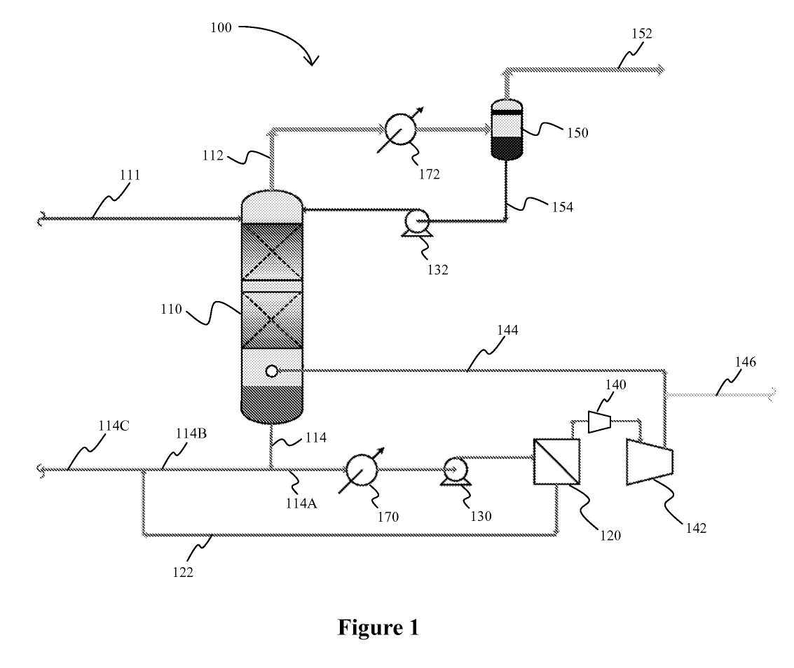

For example, FIG. 1 depicts one preferred schematic configuration 100 in which a regenerator 110 is configured to receive from an absorber (not shown) a rich solvent stream 111 and to produce a regenerator overhead stream 112, typically containing CO2 and/or H2S. The absorber further produces a regenerator bottom product stream 114 (i.e., the regenerated aqueous solvent). Desorption of the CO2 and/or H2S in the regenerator is effected in large part by stripping medium 144, typically steam, which is introduced near the bottom of the regenerator 110. The regenerator overhead stream 112 is cooled in overhead condenser 172 in conventional manner, and the condensed water is separated in overhead separator drum 150 and returned to the regenerator 110 via stream 154 and reflux pump 132. Acid gas stream 152 is fed to a location as suitable (e.g., H2S to Claus plant, or CO2 to EOR or sequestration).

The regenerator bottom product 114 is then split into a first portion 114A that is fed to the pervaporation unit 120, while a second portion 114B is fed as regenerated (lean) solvent to the absorber. Where desired, the first portion 114A is cooled in cooler 170 to a desired temperature (e.g., between 40-90° C.), and pumped in pump 130 to suitable pressure (e.g., between 1-5 bar, more typically between 5-30 bar, and most typically between 1 and 50 bat). However, it should be noted that a cooler may not be required as cooling is predominantly used to protect the membrane of the pervaporation unit. Where needed, a vacuum pump 140 may be employed at the permeate side of the pervaporation unit 120 to assist in generation of a proper pressure gradient across the pervaporation membrane. It should be noted that contrary to common use, the permeate is not condensed. Thus, it is generally preferred that the steam permeate from the pervaporation unit is then brought to regenerator pressure via compressor (or ejector) 142, if required, and introduced into the regenerator 110 as stripping medium. Start-up and/or additional steam may be supplied to the regenerator 110 via line 146, though this stream generally has zero flow during normal operation. The retentate from the pervaporation unit is fed to the absorber as stream 122, which is most preferably combined with the second portion 114B to so form a combined lean solvent stream 114C.

In an especially contemplated aspect of the inventive subject matter, the flow rate of the first portion of the solvent that is fed to the pervaporation membrane is dependent on the regenerator steam demand and the efficiency of the membrane. Most preferably, the steam demand is limited such that the desired degree of removal of the acid gas from the solvent is achieved in the regenerator, as increased steam injection results in over-stripping of the solvent at increased operating cost. Once the steam demand is determined, the flow rate of regenerated solvent that is fed to the membrane is set such that the water removal rate is equal to the required steam rate, which will typically depend on the type of membrane, the pressure gradient across the membrane, and the solvent concentration. It should be appreciated that in this manner, the water balance in the overall plant is unaffected by the pervaporation membrane unit. Thus, when the two portions (i.e., the retentate and the second portion) of the lean solvent are remixed upstream of the absorber, proper solvent composition will be achieved. For example, a membrane with a relatively high water removal rate would require a smaller portion of the regenerated solvent flow than would a membrane with a lower water removal rate. In order to minimize operating and capital costs, it is generally preferred to minimize the flow rate of regenerated solvent through the membrane for a given desired steam rate.

Of course, it should be recognized that the flow rate ratio of first to second portion of the regenerated solvent will depend on multiple factors, and a person of ordinary skill in the art will be readily able to ascertain the appropriate flow ratio. While not limiting to the inventive subject matter, it is typically preferred that the entire steam demand of the regenerator is provided by the pervaporation unit. However, in less preferred aspects, the pervaporation unit may be used to supplement a steam stream or other regeneration medium that is generated from a source other than the lean solvent (e.g. a typical steam-heated reboiler). It should also be recognized that certain operating conditions may exist where additional steam may be imported (e.g., during start-up).

Among other advantages of the above system and methods, it should be appreciated that direct steam injection into the regenerator column is an effective method for introducing into the system the energy required for releasing the captured component from the solvent. However, any steam injection results in water addition to the solvent system, which must be subsequently removed to maintain the solvent composition. The configurations and methods presented herein offer a unique solution to this problem. Water is removed from the aqueous solvent leaving the bottom of a regenerator using pervaporation separation where permeate is concentrated in water that is already in the vapor phase. This permeate vapor stream is then compressed to the regenerator pressure and reintroduced to the bottom of the regenerator. The so internally generated steam is then used to regenerate the solvent, and is condensed in the column or in the overhead condenser and returned to the column as reflux. The condensed water is again separated out from the solvent in the pervaporation membrane. Consequently, it should be appreciated that while live steam is added to the regenerator, external water or steam sources are not required, thus maintaining a neutral water balance for the regenerator.

Depending on the operating conditions of the regenerator various modifications may be implemented to facilitate the pervaporation process and to maintain the advantages of the present system. For example, where the solvent has a relatively high temperature, one or more coolers, heat exchangers (e.g., using coolant or rich solvent) may be used to reduce the temperature of the lean solvent to a temperature that reduces membrane deterioration of the pervaporation unit. On the other hand, where the lean solvent temperature is relatively low, one or more heat sources may provide heat to the portion of the lean solvent. Similarly, where the operating pressure of the regenerator is relatively low (i.e., below a pressure suitable for operation of the pervaporation unit), a pump may be used to boost the pressure differential across the membrane. Alternatively, or additionally, a vacuum pump may be coupled to the steam side of the pervaporation unit to facilitate or enhance separation of steam from the lean solvent. Most typically, regenerator configurations for regeneration of an acid gas absorbing solvent will include at least one of a vacuum unit downstream and a pump upstream of the pervaporation unit to provide for an adequate pressure gradient and steam release.

With respect to appropriate pervaporation units it should be recognized that there are various pervaporation units known in the art, and all of those are deemed suitable for use in conjunction with the teachings presented herein. However, it is especially preferred that the pervaporation unit comprises a membrane system that is permeable for water/steam and largely impermeable for organic solvents. For example, one suitable pervaporation system is described in U.S. Pat. No. 5,051,188, which is incorporated by reference herein. Further known suitable membrane systems include those described in U.S. Pat. Nos. 5,248,427, 5,707,522, 7,166,224, 6,755,975, and U.S. Pat. App. No. 2008/0099400, all of which are incorporated by reference herein.

In further contemplated aspects of the inventive subject matter, it should be noted that the configurations and methods presented herein can also be employed in systems other than amine-solvent regeneration, and all systems are deemed suitable in which steam can be recovered from a process stream using pervaporation systems. Such steam could be used as stripping medium, as a reactant or solvent in a reaction, or as motive fluid in a power generation scheme. Therefore, suitable fluids that are fed into the pervaporation unit need not be limited to acid gas adsorbing solvents, but can include all aqueous solutions used in the processes pointed out above. Consequently, the pervaporation unit may be configured in various manners, including serial and parallel units having identical or distinct permeability.

Moreover, it is contemplated that the pervaporation unit may also be used in systems where water is to be removed from an aqueous process fluid (e.g., chemical reaction in which excess water is formed), wherein the fluid is preferably at a relatively high pressure (e.g., at least 5 bar). Water can then be removed in the form of steam, which may then be used as low pressure steam.

Thus, specific embodiments and applications of solvent regeneration with reduced steam demand have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of regenerating a solvent, comprising:
stripping the solvent in a regenerator using steam as a stripping medium to produce a regenerator overhead and a regenerator bottom product;
passing at least a portion of the regenerator bottom product through a pervaporation unit to produce a vapor phase that is enriched in steam; and
feeding the vapor phase into the regenerator to thereby supply at least part of the stripping medium.

2. The method of claim 1 further comprising a step of increasing pressure of the portion of the regenerator bottom product upstream of the pervaporation unit and operating a vacuum unit downstream of the pervaporation unit to produce a pressure gradient across the pervaporation unit.

3. The method of claim 1 further comprising a step of compressing the vapor phase prior to feeding the vapor phase into the regenerator.

4. The method of claim 2 wherein the step of compressing the vapor phase comprises use of a compressor or an ejector.

5. The method of claim 1 wherein the portion of the regenerator bottom product is selected such that an amount of steam in the vapor phase is equal to an amount of steam required for regeneration of the solvent in the regenerator to a desired degree.

6. The method of claim 1 wherein the portion of the regenerator bottom product is between 70 vol % and 100 vol % of total regenerator bottom product.

7. The method of claim 1 wherein the solvent is an amine-based solvent.

8. A solvent regeneration system, comprising:
a steam regenerator that is configured to allow use of steam as a stripping medium to so produce a regenerator overhead and a regenerator bottom product;
a pervaporation unit fluidly coupled to the steam regenerator to allow feeding of at least a portion of the regenerator bottom product to the pervaporation unit to so produce a vapor phase that is enriched in steam; and
a conduit fluidly coupled to the pervaporation unit and configured to allow feeding of the vapor phase into the regenerator to thereby supply at least part of the stripping medium.

9. The regeneration system of claim 8 further comprising a pump that is fluidly and upstream coupled to the pervaporation unit, and a vacuum pump that is fluidly and downstream coupled to the pervaporation unit to allow generation a pressure gradient across the pervaporation unit.

10. The regeneration system of claim 8 further comprising a compressor fluidly coupled to the pervaporation unit and configured to provide the vapor phase as a compressed stream to the steam regenerator.

11. The regeneration system of claim 8 further comprising a conduit that allows combination of retentate from the pervaporation unit and another portion of the regenerator bottom product.

12. A method of providing steam to a steam regenerator that is configured to produce a regenerator bottom product from an aqueous solvent, comprising a step of passing a portion of the regenerator bottom product across pervaporation unit to so form a steam permeate, and feeding the steam permeate to the steam regenerator.

13. The method of claim 12 wherein the portion is selected in an amount effective to maintain neutral water balance for the steam regenerator.

14. The method of claim 12 further comprising a step of combining another portion of the regenerator bottom product with retentate from the pervaporation unit to form a combined lean solvent.

15. The method of claim 14 further comprising a step of feeding the combined lean solvent to an absorber.
